(19) United States
(12) Patent Application Publication
(10) Pub. No.: US 2010/0181461 A1
(43) Pub. Date: Jul. 22, 2010

(54) VEHICLE SEAT TRACK

(76) Inventors: Alexander I. Balin, Ann Arbor, MI (US); Dinu V. Moraru, Westland, MI (US)

Correspondence Address: FOLEY AND LARDNER LLP;SUITE 500, 3000 K STREET NW, WASHINGTON, DC, 20007, US

(21) Appl. No.: 12/663,776

(22) PCT Filed: Jun. 10, 2008
(86) PCT No.: PCT/US2008/066433

§ 371 Date: Apr. 6, 2010

Related U.S. Application Data
(60) Provisional application No. 60/934,097, filed on Jun. 11, 2007.

(51) Int. Cl. B60N 2/07; F16M 13/00

(52) U.S. Cl. 248/429

(57) ABSTRACT

A track system for adjusting the position of a vehicle component is provided. The track system comprises a first lower track member (22), a second lower track member (26) and an upper track assembly (24, 28) moveable relative the first lower track member (22) and the second lower track member (26). The upper track assembly (24, 28) includes a first upper track member (24) associated with the first lower track member (22), a second upper track member (28) associated with the second lower track member (26) and a member (29) extending between the first upper track member (24) and the second upper track member (28) to support the first upper track member (24) and the second upper track member (24) in a use position relative to the first lower track member (22) and the second lower track member (26). The first upper track member (24) and the second upper track member (28) are not supported in the use position until the member (29) is provided.

### CROSS-REFERENCE TO RELATED PATENT APPLICATIONS

This application claims the benefit under 35 U.S.C. 119(e) of U.S. Provisional Application No. 60/934,097, having a filing date of Jun. 11, 2007, titled “VEHICLE SEAT TRACK AND LATCH ASSEMBLY,” the complete disclosure of which is hereby incorporated by reference.

### BACKGROUND

The present disclosure relates generally to the field of adjustable vehicle seat assemblies. More particularly, the present disclosure relates to the field of track systems or arrangements for use with adjustable vehicle seat assemblies.

Vehicle seat assemblies are typically provided with a track system that enables the position of the seat assembly within a motor vehicle to be adjusted in the forward and rearward direction. Such adjustment capability is desirable to enable vehicle operators of various sizes to be seated comfortably and safely within the motor vehicle. Such seat assemblies typically include two or more tracks that move relative to one another. The tracks are generally self-supportive, meaning that the tracks can move relative to one another in an operable manner before being mounted to the seat assembly, to an adjacent track, and/or the vehicle. Such tracks may include a latching mechanism that releasably retains the tracks (and therefore the seat assembly) in a locked position relative to one another until the latch mechanism is released. Once the latch mechanism is released, the tracks can be moved relative to one another, which allows the occupant of the seat assembly to adjust the position of the seat assembly and to then reengage or release the latching mechanism to hold the seat in the new location.

To provide a reduced mass, low cost, reliable, widely acceptable seat track system or arrangement for providing translational adjustment would represent a significant advance in the art.

### SUMMARY

One embodiment relates to a track system for adjusting the position of a vehicle component. The track system comprises a first lower track member, a second lower track member and an upper track assembly moveable relative the first lower track member and the second lower track member. The upper track assembly includes a first upper track member associated with the first lower track member, a second upper track member associated with the second lower track member and a member extending between the first upper track member and the second upper track member to support the first upper track member and the second upper track member in a use position relative to the first lower track member and the second lower track member. The first upper track member and the second upper track member are not supported in the use position until the member is provided.

Another embodiment relates to a track system for adjusting the position of a vehicle component. The track system comprises a first track member including a first portion and a second track member selectively moveable relative to the first track member. The second track member includes a second portion. The track system also comprises a member coupled to the second track member and at least partially surrounding the first track member. The member is configured to alter load transfer from the second track member to the first track member.

### BRIEF DESCRIPTION OF THE DRAWINGS

FIG. 1 is an isometric view of a vehicle with a seat according to an exemplary embodiment.

FIG. 2 is an isometric view of the seat in FIG. 1 including a seat track according to an exemplary embodiment.

FIG. 3 is an isometric view of the seat in FIG. 2 showing the internal support structure according to an exemplary embodiment.

FIG. 4 is an isometric view of a seat track system according to an exemplary embodiment.

FIG. 5 is a front view of the seat track system in FIG. 4 according to an exemplary embodiment.

FIG. 6 is a partial exploded view of the seat track system in FIG. 4 showing the assembly of the seat track system according to an exemplary embodiment.

FIG. 7 is an exploded view of the seat track system in FIG. 4 according to an exemplary embodiment.

FIG. 8 is a detailed, partial front view of one side of the seat track system in FIG. 5 showing the upper seat track member in an unassembled (free) state.

FIG. 9 is another detailed, partial front view of one side of the seat track system in FIG. 5 showing the upper seat track member in an assembled or use position in solid lines and in preassembled or nonuse position in phantom lines.

FIG. 10 is an isometric view of a seat track system according to another exemplary embodiment.

FIG. 11 is an exploded isometric view of the seat track system in FIG. 10 according to exemplary embodiment.

FIG. 12 is an isometric view of a support member of the seat track system in FIG. 11 according to exemplary embodiment.

FIG. 13 is an isometric view of the support member in FIG. 12 coupled to the seat track system and showing a load applied to the seat track system.

FIG. 14 is a cross-section of the seat track system in FIG. 13 taken through the support member.

FIG. 15 is a cross-section of the seat track system in FIG. 13 shown without the support member.

### DETAILED DESCRIPTION

Before the description of various exemplary embodiments of the track system, several general comments are warranted about the applicability and the scope of the present disclosure. While the illustrations relate to a seat (also can be referred to as a chair) particularly adapted for motor vehicles, such as cars, SUVs, vans, trucks, buses and the like, the track system disclosed herein is also applicable to a seat for use in aircraft, railroad vehicles, nautical vehicles, or other environments.

For purposes of this disclosure, the term coupled means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components or the two components and any additional member being attached to one another. Such joining may be permanent in nature or alternatively may be removable or releasable in nature.

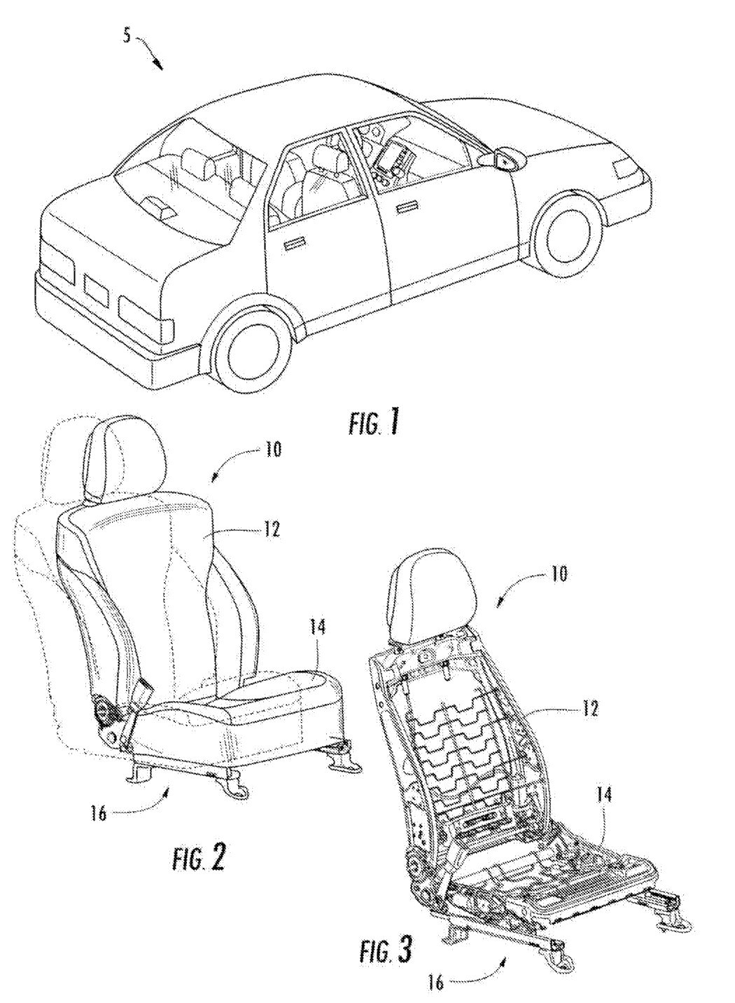

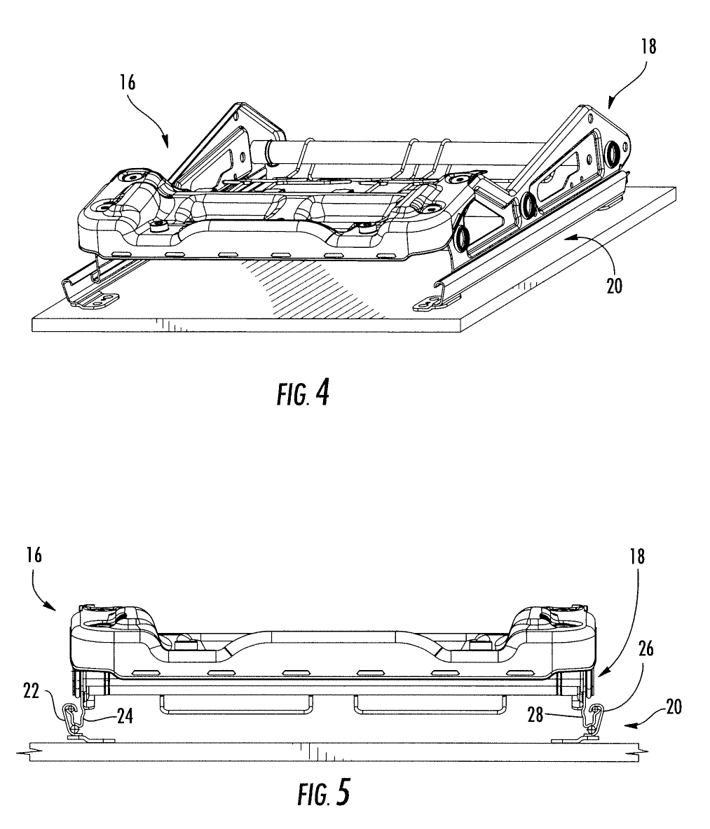

Referring to the FIGURES and in particular to FIG. 1, a vehicle 5 is shown according to an exemplary embodiment. Vehicle 5, shown as a 4-door sedan, includes one or more vehicle seats 10 that are configured to receive an occupant and are coupled to vehicle 5. As shown in more detail in FIGS. 2 and 3, vehicle seat 10 includes an upper portion (e.g., backrest, etc.), shown as a seat back 12, that extends substantially upward, a generally horizontal lower portion (e.g., seat base, etc.), shown as a seat bottom 14, that extends outward from the bottom end of seat back 12, and a support structure (e.g., rail system, etc.), shown as a seat track system 16. Seat back 12 may be pivotally connected to seat bottom 14 through a recliner mechanism, or may be fixed relative thereto. Vehicle seat 10 is coupled to vehicle 5 through seat track system 16, which is configured to allow a seat occupant to selectively adjust the position of vehicle seat 10 in a translational manner relative to a length of seat track system 16 (as shown in phantom lines in FIG. 2). For example, seat track system 16 may be arranged within vehicle 5 in a manner that allows a vehicle seat occupant to selectively adjust the position of vehicle seat 10 in a fore and aft direction (e.g., forward and rearward with respect to vehicle 5).

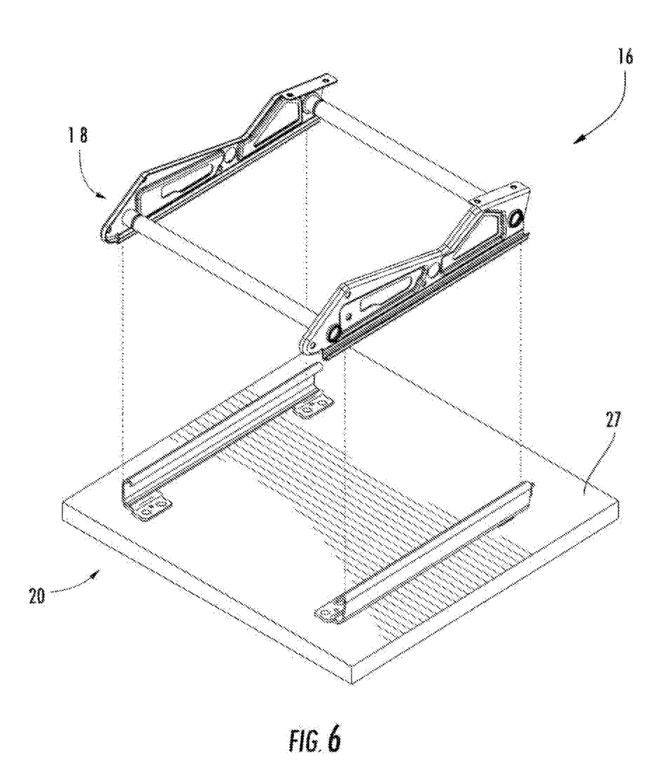

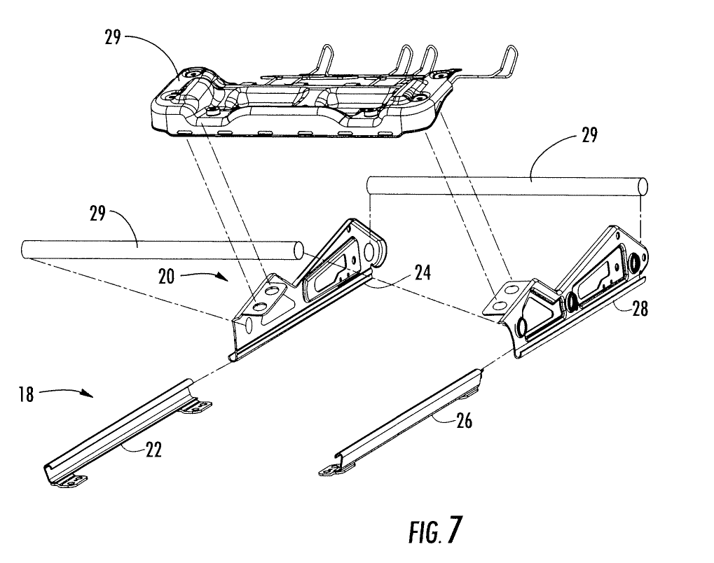

Referring to FIGS. 4 through 6, according to an exemplary embodiment, seat track system 16 generally includes a first track assembly, shown as an upper track assembly 18, and a second track assembly, shown as a lower track assembly 20. According to the embodiment illustrated, upper track assembly 18 is configured to be fixed relative to vehicle seat 10 (e.g., seat bottom 14, etc.), while lower track assembly 20 is configured to be fixed relative to vehicle 5 (e.g., a vehicle floor or floor panel, etc.). Upper track assembly 18 and lower track assembly 20 are configured to cooperate with each other to allow for the movement or translation of the vehicle seat 10 relative to vehicle 5 when a vehicle seat occupant actuates a lever or other actuator.

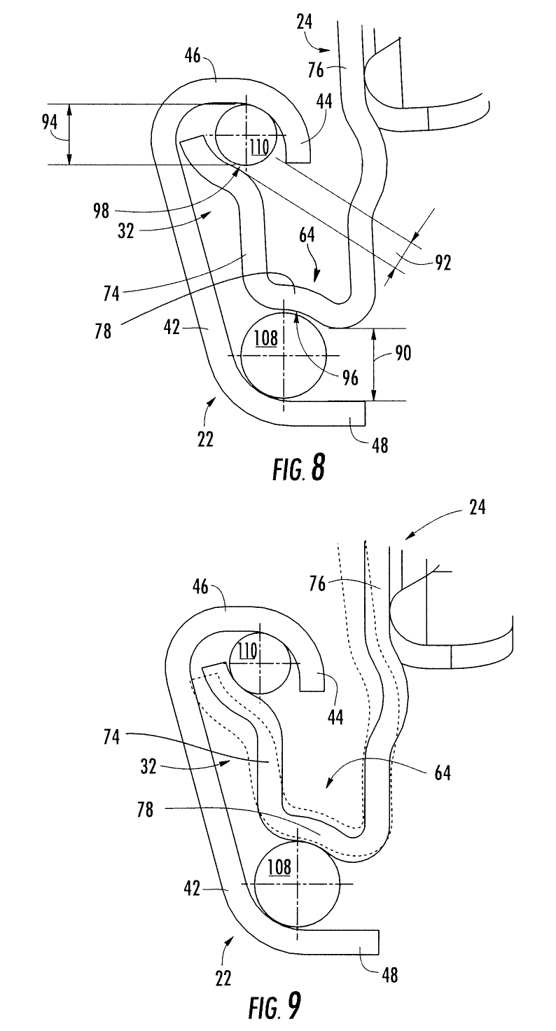

Referring to FIG. 7, upper track assembly 18 generally includes a first track member (e.g., right side track member, rail, slide, guide, etc.), shown as an upper inboard track member 24, a second track member (e.g., left side track member, rail, slide, guide, etc.), shown as an upper outboard track member 28, and a member (e.g., cross support, cross bar, seat base, etc.), shown as a first support member 29, extending between upper inboard track member 24 and upper outboard track member 28. According to the embodiment illustrated, upper inboard track member 24 and upper outboard track member 28 are coupled by first support member 29 (e.g., seat bottom 14, etc.) in a generally spaced-apart and parallel relationship, with upper inboard track member 24 being located at the inboard side of vehicle seat 10 and upper outboard track member 28 being located at the outboard side of vehicle seat 10.

Still referring to FIG. 7, lower track assembly 20 generally includes a first track member (e.g., right side track member, rail, slide, guide, etc.), shown as a lower inboard track member 22, a second track member (e.g., left side track member, rail, slide, guide, etc.), shown as a lower outboard track member 26, and a member (e.g., cross support, cross bar, floor pan, etc.), shown as a second support member 27, extending between lower inboard track member 22 and lower outboard track member 26. According to the embodiment illustrated, lower inboard track member 22 and lower outboard track member 26 are configured to be coupled by second support member 27 (e.g., vehicle floor, a member used to hold lower inboard track member 22 and lower outboard track member 26 before and/or until lower track assembly 20 is mounted to vehicle 5, etc.) in a generally spaced-apart and parallel relationship, with lower inboard track member 22 being aligned with upper inboard track member and lower outboard track member 26 being aligned with upper outboard track member 28.

The configuration (e.g., profile, etc.) of the track members of upper track assembly 18 and lower track assembly 20 provide a reduced cost and reduced mass track system compared to conventional track systems. The mass of the track members can be reduced because seat track system 16 relies upon the structure of vehicle seat 10 and vehicle 5 for stability, strength, rigidity and/or alignment rather than having the track members be self-supportive as conventional track assemblies are configured. For example, upper track assembly 18 may utilize seat bottom 14 as first support member 29, while lower track assembly 20 may utilize the vehicle floor as second support member 27. Further, without first and second support members 29 and 27, upper inboard track member 24 would fall out of alignment with lower inboard track member 22 leaving track system 16 substantially inoperable for its intended purpose. Advantageously, with the reduced mass, the track members have a smaller width than conventional track assemblies. The thinner profile of the track members provide more space for a latch and release system for the track system.

Referring back to FIG. 5, and according to the embodiment illustrated, upper inboard track member 24 is a mirror image of upper outboard track member 28, while lower inboard track member 22 is a mirror image of lower outboard track member 26. Accordingly, the same reference numbers will be used to refer to like components of the upper and lower inboard and outboard track members. According to the various alternative embodiments, the track members need not necessarily be a mirror image.

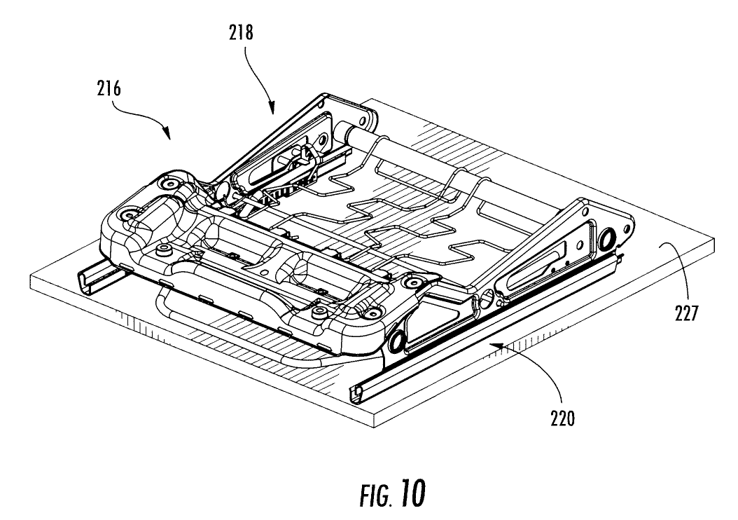

Referring to FIGS. 8 and 9, lower inboard track member 22 is an elongated and generally rigid member that is configured to serve as a guide for upper inboard track member 24. According to an exemplary embodiment, lower inboard track member 22 includes a channel 32. Channel 32 of lower inboard track member 22 is a generally U-shaped channel that faces downwardly. Channel 32 is formed by two generally vertical sidewalls 42 and 44 (the two legs of the “U”) that are joined together by a generally horizontal intermediate wall 46 (the base of the “U”). The location of intermediate wall 46 above base 48 of inboard lower track member 22 defines the height of channel 32. A generally horizontal base 48 extends outward from sidewall 42 opposite of and generally parallel to intermediate wall 46. Intermediate wall 46, sidewall 42 and base 48 define an inwardly facing channel. According to an alternative embodiment, base 48 may include an upwardly extending projection or formed region between a free end of base 48 and sidewall 42 to assist in retaining a friction reducing member (detailed below).

Upper inboard track member 24 is an elongated and generally rigid member having an axial length that is configured to engage lower inboard track member 22 in a manner that allows upper inboard track member 24 to move (e.g., translate or slide) in an axial direction of lower inboard track member 22. According to an exemplary embodiment, upper inboard track member 24 forms a channel 64. According to the embodiment illustrated, channel 64 is a generally U-shaped channel that faces upwardly (with one leg of the “U,” e.g., a leg closer to the center of vehicle seat 10, being longer than the other). Channel 64 is formed by two generally vertical sidewalls 74 and 76 (the two legs of the “U”) that are joined together by an intermediate wall 78 (the base of the “U”) that inclines upwardly as it extends from inner sidewall 76 to outer sidewall 74. Outer sidewall 74 is shorter than inner sidewall 76 and extends to a height that is less than the height to which inner sidewall 76 extends. According to the embodiment illustrated, a top portion of outer sidewall 74 and a central portion of inner sidewall 76 include a curved portion that may be provided to receive a friction reducing member. While channel 64 is referred to as generally U-shaped, channel 64 is not intended to be limited to any particular shape. According to the various alternative embodiments, channel 64 may be any shape that is suitable for cooperating with lower inboard track member 22 and/or one or more friction reducing members.

When upper track assembly 18 and lower track assembly 20 are assembled (e.g., provided in a use position, etc.), friction reducing members (e.g., balls, rollers, bushings, bearings, rolling elements, etc.), shown as ball bearings 108 and 110, are provided to maintain the alignment between lower inboard track member 22 and upper inboard track member 24 and/or to reduce the friction between lower inboard track member 22 and upper inboard track member 24 during the movement of upper track assembly 18. According to an exemplary embodiment, bearings 108 and 110 each represent a plurality of similarly located bearings that are disposed along the length of seat track system 16, generally between lower inboard track member 22 and upper inboard track member 24. For purposes of this disclosure, the phrases set of bearings and set of friction reducing members are intended to refer to the plurality of similarly located and positioned bearings disposed along the length of a track in a row.

According to an exemplary embodiment, bearing 108 (e.g., and a plurality of similar bearings 108 extending in an axial direction) is generally positioned between intermediate wall 78 of upper inboard track member 24 and the intersection between base 48 and sidewall 42 of lower inboard track member 22. To accommodate bearing 108, intermediate wall 78 is curved upward (e.g., the bearing supporting side of intermediate wall 78 is generally concave) and the intersection between base 48 and sidewall 42 of lower inboard track member 22 has a radius that is configured to receive bearing 108. Bearing 110 (e.g., and a plurality of similar bearings 110 extending in an axial direction) is generally positioned between sidewall 74 of upper inboard track member 24 and the intersection between intermediate wall 46 and sidewall 44 of lower inboard track member 22, each of which has a radius that is configured to receive bearing 110.

According to other exemplary embodiments, the size of each of the bearings may vary depending on the precise configuration and spacing of the upper and lower tracks. According to other exemplary embodiments, the number and location of the friction members or bearings may vary. For example, seat track system 16 may be configured to include bearings at one, two, three, or more than three locations along the cross-section of the track arrangement rather than at four locations. According to still other exemplary embodiments, the friction reducing members may be one of a variety of different friction reducing members, including roller bearings, needle bearings, oval-shaped bearings, bushings, slide blocks (e.g., plastic blocks, etc.), etc. According to still other exemplary embodiments, one or more different types of friction reducing members may be used together in the track arrangement. According to still other exemplary embodiments, the bearings may be fixed to, or captured within, one track or may be free to slide or move within the respective channel along the length of the tracks (until they hit the stops). According to still other exemplary embodiments, one or more sets of the bearings may be provided in a body, guide, carriage, or cage that fixes the location of each bearing in the set relative to the other bearings in the set but still allows each bearing to freely roll.

Bearings 108 and 110 are substantially trapped within seat track system 16 by the geometry of lower inboard track member 22 and upper inboard track member 24. The clearance or gap 90 between the intersection of intermediate wall 78 and sidewall 76 of upper inboard track member 24 and base 48 is less than the diameter of bearing 108. Similarly, the clearance or gap 92 between sidewall 44 and intermediate wall 78 and gap 94 between sidewall 74 and intermediate wall 46 is less than the diameter of bearing 108.

Referring particularly to FIG. 8, in an unassembled or free state (e.g., a non-use position, etc.), when upper inboard track member 24 and upper outboard track member 28 are not coupled together via first support member 29 and/or when lower inboard track member 22 and lower outboard track member 26 are not coupled together via second support member 27 there is a clearance or gap 96 between bearing 108 and intermediate wall 78 (or between bearing 108 and the intersection between base 48 and sidewall 42 of lower inboard track member 22) and a clearance or gap 98 between bearing 110 and sidewall 74 of upper inboard track member 24 (or between bearing 110 and the intersection between intermediate wall 46 and sidewall 44 of lower track 22). Lower track assembly 20 is coupled to vehicle 5 by coupling base 48 to a suitable structure such as the floor structure, or an intermediate member, of vehicle 5. Upper track assembly 18 is coupled to vehicle seat 10 by coupling the inner sidewall 76 to the seat bottom 14.

Referring particularly to FIG. 9, when upper track assembly 18 is coupled to lower track assembly 20 (e.g., when seat track system 16 moves to the use position), inner sidewall 76 of upper inboard track member 24 is deflected and the size of gaps 96 and 98 are reduced, creating an interference between upper inboard track member 24 and lower inboard track member 22 and bearings 108 and 110. The interference between the components of seat track system 16 decreases the free play (or looseness) and increase the stability of the system.

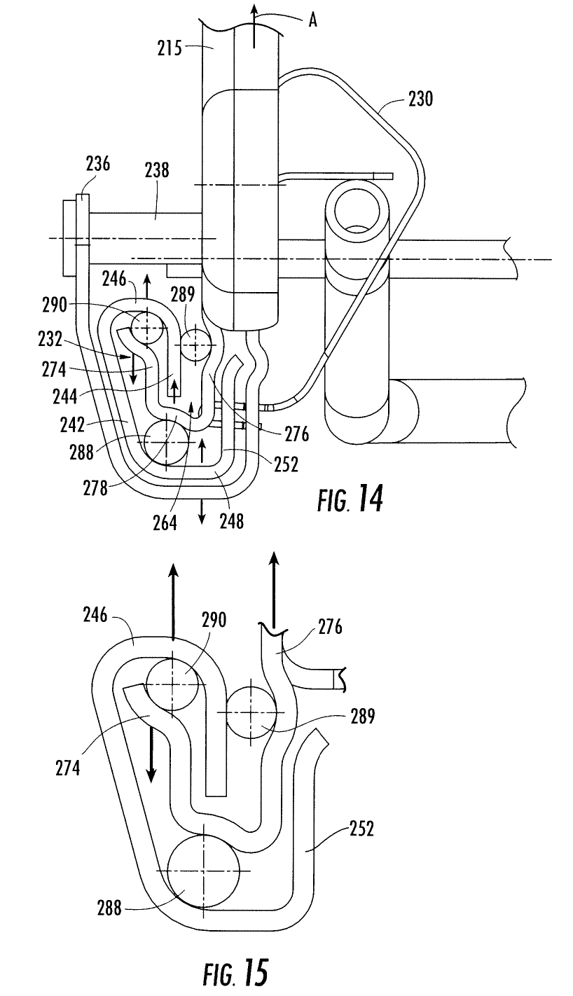

The configurations of upper inboard track member 24 and lower inboard track member 22 are not limited to the embodiment shown in FIGS. 4 through 9. Upper inboard track member 24 and lower inboard track member 22 can be of any configuration that provides for a reduced mass structure that utilizes the rigidity of a vehicle seat and/or the vehicle for its stability. For example, as detailed below, FIG. 15 shows a seat track system 216 according to another exemplary embodiment. Seat track system 216 is similar to seat track system 16, but lower inboard track member 222 includes a third vertical sidewall 252 that extends upward from base 248 opposite vertical wall 242 and sidewall 244 extends further than sidewall 44. Third vertical sidewall 252, base 248 and vertical wall 242 define an upwardly facing channel. Further, an additional friction reducing member, shown as a bearing 289, is positioned between sidewall 276 of upper inboard track member 224 and sidewall 244 of lower inboard track member 222.

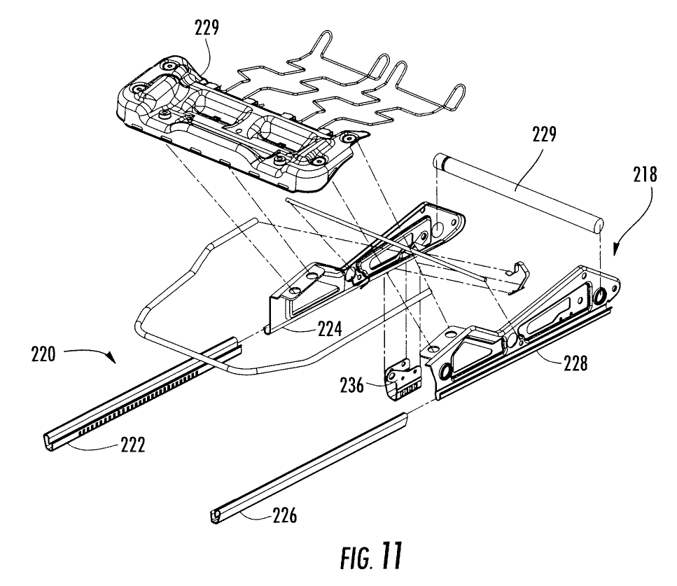

Referring now to FIGS. 10 through 14, a seat track system 216 is shown according to another exemplary embodiment. Seat track system 216 includes an upper track assembly 218 and a lower track assembly 220. According to the embodiment illustrated, upper track assembly 218 generally includes a first track member (e.g., right side track member, rail, slide, guide, etc.), shown as an upper inboard track member 224, a second track member (e.g., left side track member, rail, slide, guide, etc.), shown as an upper outboard track member 228, and a member (e.g., cross support, cross bar, seat base, etc.), shown as a first support member 229, extending between upper inboard track member 224 and upper outboard track member 228.

According to the embodiment illustrated, lower track assembly 220 generally includes a first track member (e.g., right side track member, rail, slide, guide, etc.), shown as a lower inboard track member 222, a second track member (e.g., left side track member, rail, slide, guide, etc.), shown as a lower outboard track member 226, and a member (e.g., cross support, cross bar, floor pan, etc.), shown as a second support member 227, extending between lower inboard track member and lower outboard track member 226.

Similar to the exemplary embodiment detailed above with reference to FIGS. 4 through 9, the configuration (e.g., profile, etc.) of the track members of upper track assembly 218 and lower track assembly 220 provide a reduced cost and reduced mass track system compared to conventional track systems. The mass of the track members can be reduced because seat track system 216 relies upon the structure of vehicle seat 210 and vehicle 5 for stability, strength, rigidity and/or alignment rather than having the track members be self-supportive as conventional track assemblies are configured. For example, upper track assembly 218 may utilize seat bottom 14 as first support member 229, while lower track assembly 220 may utilize the vehicle floor as second support member 227. Further, without first and second support members 229 and 227, upper inboard track member 24 would fall out of alignment with lower inboard track member 222 leaving track system 216 substantially inoperable for its intended purpose.

According to the embodiment illustrated, upper inboard track member 224 is a mirror image of upper outboard track member 228, while lower inboard track member 222 is a mirror image of lower outboard track member 226. Accordingly, the same reference numbers will be used to refer to like components of the upper and lower inboard and outboard track members. According to the various alternative embodiments, the track members need not necessarily be a mirror image.

Referring in particular to FIG. 14, lower inboard track member 222 (e.g., track, rail, slide, guide, etc.) is an elongated and generally rigid member that is configured to be coupled to a structure, such as a floor structure of an automobile, and to generally serve as a guide for upper inboard track member 224. According to one exemplary embodiment, lower inboard track member 222 includes a channel 232.

Channel 232 of lower inboard track member 222 is a generally U-shaped channel that faces downwardly. Channel 232 is formed by two generally vertical sidewalls 242 and 244 (the two legs of the “U”) that are joined together by a generally horizontal intermediate wall 246 (the base of the “U”). The location of intermediate wall 246 above the base 248 of lower inboard track member 222 defines the height of channel 232. A generally horizontal base 248 extends outward from sidewall 242 opposite of and generally parallel to intermediate wall 246. Lower inboard track member 222 further includes a third vertical sidewall 252 that extends upward from base 248 opposite of vertical wall 242.

Upper inboard track member 224 (e.g., track, rail, slide, etc.) is an elongated and generally rigid member having an axial length and is configured to be coupled to lower inboard track member 222 in a manner that allows upper inboard track member 224 to move (e.g., translate or slide) in an axial direction of lower inboard track member 222. According to one exemplary embodiment, upper inboard track member 224 forms a channel 264. Channel 264 is a generally U-shaped channel that faces upwardly. Channel 264 is formed by two generally vertical sidewalls 274 and 276 (the two legs of the “U”) that are joined together by an intermediate wall 278 (the base of the “U”) that inclines upwardly as it extends from inner sidewall 276 to outer sidewall 274. According to an exemplary embodiment, sidewall 276 of upper inboard track member 224 is coupled to a side member 215 of seat bottom 14 (e.g., by being integrally formed therewith, etc.).

Friction reducing members (e.g., balls, rollers, bushings, bearings, rolling elements, slide blocks (e.g., plastic blocks, etc.), etc.), shown as ball bearings 288, 289 and 290, are intended to provide and maintain the alignment between lower inboard track member 222 and upper inboard track member 224 and/or to reduce the friction between lower inboard track member 222 and upper inboard track member 224 during the movement of upper inboard track member 224. According to one exemplary embodiment, bearings 288, 289 and 290 each represent a plurality of similarly located bearings that are disposed along the length of seat track system 216, generally between lower inboard track member 222 and upper inboard track member 224. The phrases set of bearings and set of friction reducing members are intended to refer to the plurality of similarly located and positioned bearings disposed along the length of a track in a row. Bearing 288 is generally positioned between intermediate wall 278 of upper inboard track member 224 and intersection of base 248 and sidewall 242 of lower inboard track member 222. To accommodate bearing 288, intermediate wall 278 is formed or curved upward (e.g., the bearing supporting side of the intermediate wall 278 is generally concave) and intersection between base 248 and sidewall 242 of lower inboard track member 222 has a radius that is configured to receive bearing 288. Bearing 289 (and the plurality of other similar bearings) is generally positioned between sidewall 276 of upper inboard track member 224 and sidewall 244 of lower inboard track member 222. To accommodate bearing 289, sidewall 276 is formed or curved inward (e.g., the bearing supporting side of intermediate wall 276 is generally concave). Bearing 290 (and the plurality of other similar bearings) is generally positioned between intersection of intermediate wall 278 and sidewall 274 of upper inboard track member 224 and the intersection between intermediate wall 246 and sidewall 244 of lower inboard track member 222, each of which has a radius that is configured to receive bearing 290.

According to one exemplary embodiment track assemblies 18 and 20 may be assembled at a first location and shipped to a second location where they are coupled to vehicle seat 10 and to vehicle 5. According to another exemplary embodiment, the track assemblies 18 and 20 may be assembled with vehicle seat 10 at one location and then shipped to a second location for installation into vehicle 5.

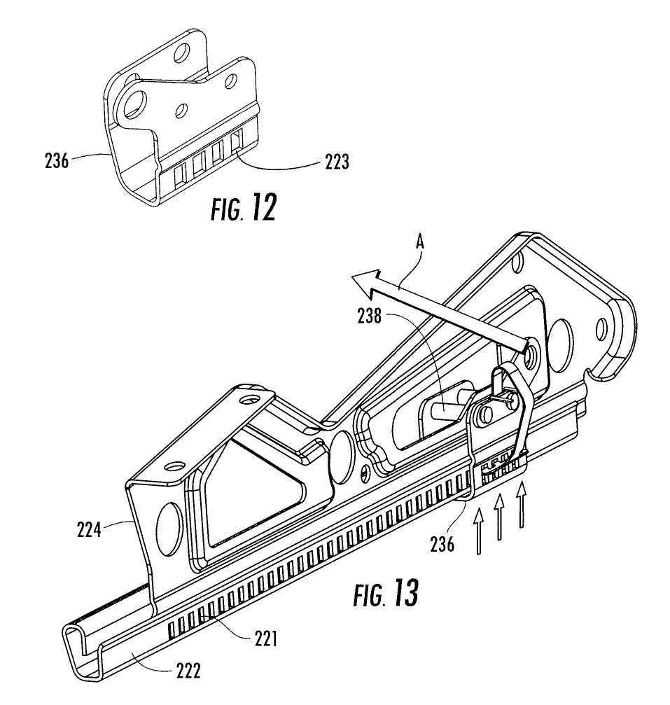

Referring to FIGS. 12 through 14, seat track system 216 also includes a member (e.g., support member, etc.), shown as a reinforcing bracket 236, coupled to upper inboard track member 224. Reinforcing bracket 236 is configured to alter load transfer that would otherwise be realized by lower inboard track member 222 and upper inboard track member 224 if reinforcing bracket 236 was not provided and a load A (shown in FIG. 13) was applied to seat track system 216. For example, reinforcing bracket 236 may distribute at least a portion of the load that would otherwise be realized by lower inboard track member 222 and/or upper inboard track member 224 to other areas on lower inboard track member 222 and/or upper inboard track member 224, other areas on seat track system 216, vehicle seat 10 and/or vehicle 5.

According to the embodiment illustrated, reinforcing bracket 236 at least partially surrounds lower inboard track member 222 and is configured to alter load transfer from upper inboard track member 224 to lower inboard track member 222. Load transfer from upper inboard track member 224 to lower inboard track member 222 may be desirable and/or beneficial due to the reduced mass profile of upper track assembly 218 and lower track assembly 220. According to an exemplary embodiment, reinforcing bracket 236 is provided as part of a latch system for seat track system 216.

Reinforcing bracket 236 is shown as a relatively thin-walled structure having a generally U-shaped cross section (laterally of the sliding direction of upper inboard track member 224 and lower inboard track member 222). The ends of reinforcing bracket 236 are coupled via one or more fasteners, shown as rivets 238, to side member 215 of seat bottom 14 that extend laterally from side member 215. Reinforcing bracket 236 is generally located complimentary around at least a portion of lower inboard track member 222. According to the embodiment illustrated, reinforcing bracket 236 includes a multitude of openings 223 that are arranged and located to correspond with openings 221 in lower inboard track member 222. Such openings may be used by a latch system to selectively lock upper track assembly 18 to lower track assembly 20.

Referring to FIGS. 13 and 14 in particular, when a force or load A is applied to seat bottom 14 (e.g., in the event of an impact, the vehicle seat occupant may apply a significant force to a safety belt that is coupled to seat bottom 14 and upper inboard track member 224, etc.), such a load is realized by upper track assembly 218 and lower track assembly 220. Such a load may attempt to peel apart (e.g., a peeling load, etc.) the connection or engagement between upper inboard track member 224 and lower inboard track member 222. To reduce the peeling load applied to upper inboard track member 224 and lower inboard track member 222 in this area, reinforcing bracket 236 is provided to alter load transfer.

With the addition of reinforcing bracket 236, reinforcing bracket 236 realizes the load because reinforcing bracket 236 is coupled to seat bottom 14 and upper inboard track member 224. Because reinforcing bracket 236 at least partially surrounds lower inboard track member 222, reinforcing bracket 236 transfers (e.g., distributes, etc.) at least a portion of this applied load to the bottom of lower inboard track member 222 thereby lessening the amount of load that must be absorbed between the engagement of upper inboard track member 224 and lower inboard track member 222. As such, reinforcing bracket 236 also for the entire section of seat track system 216 (or a substantial portion thereof) to be loaded rather than one relatively small portion of the section. Such a configuration and positioning of reinforcing bracket 236 may also change the type of load realized by seat track system from an entirely peeling load to a combination of a peeling load and a bending load.

Referring to FIG. 15, without reinforcing bracket 236, the load applied to seat bottom 14 would have to be absorbed entirely by the engagement of upper inboard track member 224 and lower inboard track member 222, which may cause upper inboard track member 224 to separate or peel away from lower inboard track member 222. It should be noted that the use of reinforcing bracket 236 is not limited to the seat track systems disclosed herein as it may be applicable for use with any seat track system wherein in may be desirable and/or beneficial to transfer a load to other areas of the seat track system and/or vehicle. It should also be noted that reinforcing bracket 236 may also be used to transfer load to another portion of seat track system 16 and/or vehicle 5. For example, reinforcing bracket 236 may be configured to transfer load to another component of vehicle 5 and/or to the actual structure of vehicle 5.

The construction and arrangement of the elements of the seat track for a vehicle seat system as shown in the exemplary embodiments provided herein is illustrative only. Although only a few embodiments of the present seat track system have been described in detail in this disclosure, those skilled in the art who review this disclosure will readily appreciate that many modifications are possible (e.g. variations in sizes, dimensions, structures, shapes and proportions of the various elements, values of parameters, mounting arrangements, use of materials, orientations, etc.) without materially departing from the novel teachings and advantages of the subject matter recited in this disclosure. Accordingly, all such modifications are intended to be included within the scope of the present disclosure. The order or sequence of any process or method steps may be varied or re-sequenced according to alternative embodiments. Other substitutions, modifications, changes and omissions may be made in the design, operating conditions and arrangement of the preferred and other exemplary embodiments without departing from the spirit of the present disclosure.

What is claimed is:

1. A track system for adjusting the position of a vehicle component, the track system comprising:
a first lower track member;
a second lower track member; and
an upper track assembly moveable relative the first lower track member and the second lower track member, the upper track assembly including a first upper track member associated with the first lower track member, a second upper track member associated with the second lower track member, a member extending between the first upper track member and the second upper track member to support the first upper track member and the second upper track member in a use position relative to the first lower track member and the second lower track member,
wherein the first upper track member and the second upper track member are not supported in the use position until the member is provided.

2. The track system of claim 1 further comprising a second member extending between the first lower track member and the second lower track member to form a lower track assembly, the second member supporting the first lower track member and the second lower track member in a use position.

3. The track system of claim 1 wherein first lower track member and the second lower track member each include a downwardly facing channel and an inwardly facing channel.

4. The track system of claim 3 wherein the first upper track member is received within the downwardly facing channel and inwardly facing channel of the first lower track member and the second upper track member is received within the downwardly facing channel and inwardly facing channel of the second lower track member.

5. The track system of claim 3 wherein the first upper track member and the second upper track member each include a single upwardly facing channel.

6. The track system of claim 5 furthering comprising a first friction reducing member provided within both the downwardly facing channels of the first lower track member and the second lower track member and the single upwardly facing channels of the first upper track member and the second upper track member.

7. The track system of claim 6 further comprising a second friction reducing member provided within the inwardly facing channels of the first lower track member and the second lower track member.

8. The track system of claim 7 further comprising a third friction reducing member provided within the single upwardly facing channels of the first upper track member and the second upper track member and outside of the downwardly facing channels of the first lower track member and the second lower track member.

9. The track system of claim 7 wherein the first lower track member and the second lower track member each further include an upwardly facing channel

10. The track system of claim 1 wherein the member is a portion of a seat base structure of a vehicle seat.

11. The track system of claim 10 wherein the first lower track member and he second lower track member are configured to be mounted to a vehicle floor.

12. A track system for adjusting the position of a vehicle component, the track system comprising:
a first track member including a first portion;
a second track member selectively moveable relative to the first track member, the second track member including a second portion; and
a member coupled to the second track member and at least partially surrounding the first track member, the member being configured to alter load transfer from the second track member to the first track member.

13. The track system of claim 12 further comprising at least one friction reducing member provided between the first portion of the first track member and the second portion of the second track member.

14. The track system of claim 12 wherein the first track member is a lower track member and the second track member is an upper track member.

15. The track system of claim 12 wherein the member is configured to alter load transfer by distributing at least a portion of the load to a different portion of the first track member.

16. The track system of claim 12 wherein the member is configured to alter load transfer by changing the type of load applied to the first track member and the second track member.

17. The track system of claim 15 wherein the member is a bracket including a portion that extends under a lower portion of the first track member.

18. The track system of claim 17 wherein the bracket is configured to alter load transfer by distributing at least a portion of the load to the lower portion of the first track member.

19. The track system of claim 12 wherein the member is a substantially U-shaped member extending around the first track member.
